(19) United States
(12) Patent Application Publication
(10) Pub. No.: US 2011/0224120 A1
(43) Pub. Date: Sep. 15, 2011

(54) WASHING, CLEANING, POST-TREATING OR AUXILIARY WASHING AGENT CONTAINING SILVER

(75) Inventors: Georg Meine, Mettmann (DE); Ralf Bunn, Krefeld (DE); Andrea Eutebach, Wuppertal (DE); Frank Sonnenschein, Haan (DE)

(73) Assignee: Henkel AG & Co. KGaA, Dusseldorf (DE)

(21) Appl. No.: 13/112,200

(22) Filed: May 20, 2011

Related U.S. Application Data
(63) Continuation of application No. PCT/EP2009/063490, filed on Oct. 15, 2009.

(30) Foreign Application Priority Data
Nov. 21, 2008 (DE) 10 2008 058 544.0

(51) Int. Cl. C11D 17/00

(52) U.S. Cl. 510/337

(57) ABSTRACT

The present invention relates to liquid washing, cleaning, post-treating or auxiliary washing agents comprising surfactant, silver and/or a silver compound, along with additional active ingredients typically used in washing, cleaning, post-treating or auxiliary washing agents, whereby the agents are stabilized by the addition of a non-neutralized fatty acid.

### CROSS-REFERENCE TO RELATED APPLICATIONS

This application is a continuation of PCT Application Ser. No. PCT/EP2009/063490, filed on Oct. 15, 2009, which claims priority under 35 U.S.C. §119 to 10 2008 058 544.0 (DE), filed on Nov. 21, 2008. The disclosures PCT/EP2009/063490 and DE 10 2008 058 544.0 are hereby incorporated by reference in their entirety.

### FIELD OF THE INVENTION

The present invention generally relates to a washing, cleaning, post-treatment, or auxiliary washing agent containing surfactant(s), silver and/or a silver compound, as well as further usual ingredients of washing, cleaning, post-treatment, or auxiliary washing agents. The invention further relates to a method for manufacturing a washing, cleaning, post-treatment, or auxiliary washing agent.

### BACKGROUND OF THE INVENTION

As a result of changes in the laundering habits of consumers, it is possible nowadays for a hygiene problem to occur while laundering textiles. Much laundry is now being washed at 40° C. or lower, on the one hand because of energy costs but also to reduce stress on the materials and colors. Many modern textiles are in fact washable only up to 30° C.

With 60° C. laundering, as was once common, almost all germs were reliably annihilated, both because of the higher temperature and as a result of the bleaching agents contained in the washing agents usually used.

In addition to the lower washing temperature, it is also usual nowadays to use liquid washing agents that as a rule are free of bleaching agents.

Textiles contaminated with bacteria, mildew, or yeast fungi therefore cannot be made germ-free to the extent necessary to protect against possible re-infection that may occur when the consumer comes into contact again with what is presumed to be clean laundry.

Antimicrobially effective compositions, and their use as washing, cleaning, post-treatment, or auxiliary washing agents, are known in the existing art. The disinfecting agents used therein are often halogen-containing substances, phenol derivatives or other aromatic hydrocarbons, any of which may be regarded as problematic for environmental compatibility reasons. Other, more compatible microbiocides have only a limited spectrum of action or are effective only under specific physical conditions. For household applications, a great need exists for antimicrobial compositions that utilize only natural constituents, yet are effective against a broad spectrum of microorganisms and are environmentally benign.

Elemental silver and silver ions exert a blocking effect on thiol enzymes in microorganisms and thus possess a high level of bactericidal and fungicidal efficacy. Silver furthermore has a germicidal action. Germ-reducing washing, cleaning, post-treatment, or auxiliary washing agents containing silver and/or silver ions are known in prior art references such as EP 1670885 A1.

However, washing, cleaning, post-treatment, or auxiliary washing agents containing silver and/or silver ions are often not stable, since the silver ions contained in the agents can react with contaminants, e.g. chloride ions, to yield light-sensitive silver chloride salts, or e.g. sulfide, to produce poorly soluble silver sulfide salts. In a (highly) alkaline medium, soluble silver ions can react first to form AgOH and then further to yield poorly soluble Ag₂O. In addition to the poor solubility of these silver salts, the silver oxides and silver sulfides in particular (despite the small quantities) cause considerable color changes, in particular a brown or black coloration, in liquid washing, cleaning, post-treatment, or auxiliary washing agents.

Accordingly, the need still exists for stable and effective silver- and/or silver ion-containing germ-reducing liquid washing, cleaning, post-treatment, or auxiliary washing agents.

### DETAILED DESCRIPTION OF THE INVENTION

The following detailed description of the invention is merely exemplary in nature and is not intended to limit the invention or the application and uses of the invention. Furthermore, there is no intent to be bound by any theory presented in the preceding background of the invention, or in the following detailed description of the invention. With that said, it has been surprising found that the presence of non- neutralized fatty acid stabilizes elemental silver and/or silver cation without any impairment of the germicidal effect from a silver and/or silver ion-containing liquid washing, cleaning, post-treatment, or auxiliary washing agent.

The present invention is a liquid washing, cleaning, post-treatment, or auxiliary washing agent comprising: (a) 2 to 60 wt % of a surfactant selected from the group consisting of anionic, nonionic, cationic, and zwitterionic surface-active agents and mixtures thereof; (b) silver in an elemental and/or oxidized form; (c) 0.01 to 10 wt % non-neutralized fatty acid; and (d) other ingredients typically used in washing and cleaning agents.

Preferably the silver compound is selected from the group consisting of silver acetate, silver citrate, silver diaminochloride complex, silver cyclodextrin complex, silver dicyanopotassium complex, silver phthalimide, silver phenylcyanamide, silver (ethylenethiourea) complex, silver imidazolate, transition metal-NHC-calix[4]arene complexes, silver crown ethers, and silver nitrate, and mixtures thereof. Most preferably the liquid washing, cleaning, post-treatment, or auxiliary washing agent contains silver nitrate.

These silver compounds exhibit sufficiently high solubility and do not precipitate out of the liquid washing, cleaning, post-treatment, or auxiliary washing agent.

Furthermore, it is preferred that the quantity of elemental silver and/or silver compound be equal to 0.0001 to 1 wt %, based on the entire liquid washing, cleaning, post-treatment, or auxiliary washing agent composition.

It is particularly preferred that the ratio of non-neutralized fatty acid to elemental silver and/or to the quantity of silver cation be greater than or equal to 8 to 1. Particularly effective stabilization of the silver or silver cation can be achieved by establishing this ratio.

It is further preferred that the quantity of non-neutralized fatty acid be between 0.01 and 10 wt %, based on the entire liquid washing, cleaning, post-treatment, or auxiliary washing agent. Effective stabilization of the silver or the silver cation is achieved with the aid of this quantity of non-neutralized fatty acid. Excessively large quantities of non-neutralized fatty acid can result in undesirable clouding of the liquid agent, since the entire quantity of non-neutralized fatty acid cannot be dissolved in the respective agent.

It may be preferred for the liquid washing, cleaning, post-treatment, or auxiliary washing agent to additionally contain 0.01 to 3 wt % (based on the liquid washing, cleaning, post-treatment, or auxiliary washing agent) ammonium hydroxide. It has surprisingly been found that particularly clear and therefore aesthetically attractive washing, cleaning, post-treatment, or auxiliary washing agents are obtained by adding even small quantities of ammonium hydroxide.

Preferred liquid washing, cleaning, post-treatment, or auxiliary washing agents contain the neutralized and non-neutralized form of a fatty acid. A stable washing, cleaning, post-treatment, or auxiliary washing agent containing fatty acid soap and silver can easily and quickly be produced by virtue of the pH of the liquid washing, cleaning, post-treatment, or auxiliary washing agent, or by adding a pH adjusting agent.

It may be preferred for the liquid washing, cleaning, post-treatment, or auxiliary washing agent to be prepared as a fabric softener that contains from 0.5 to 50 wt % cationic surfactant.

Fabric softeners in accordance with the present invention have the advantage that the laundry items come into contact with the germ-reducing silver in the last cycle of the washing machine, with the result that the number of germs on the surface of the laundry items is further reduced. In addition, the agent has a germ-reducing effect per se and thereby prevents microbial contamination of the fabric softener dispenser, which is often expressed as an unsightly black discoloration and deposit that elicits disapproval from consumers.

The invention also relates to a method of manufacturing a liquid washing, cleaning, post-treatment, or auxiliary washing agent comprising: (a) 2 to 60 wt % of a surfactant selected from the group consisting of anionic, nonionic, cationic, and zwitterionic surfactants, and mixtures thereof; (b) silver and/or a silver compound; and (c) additional ingredients typical of washing and cleaning agents, by adding from 0.01 to 10 wt % non-neutralized fatty acid, based on the entire washing, cleaning, post-treatment, or auxiliary washing agent, to the agent comprising (a)-(c).

The invention further relates to the use of non-neutralized fatty acid to stabilize silver-containing liquid washing, cleaning, post-treatment, or auxiliary washing agents.

The invention will be described below in further detail, inter alia, with reference to various examples.

As an essential constituent, the liquid washing, cleaning, post-treatment, or auxiliary washing agent contains silver and/or a silver compound.

According to the present invention, silver is utilized either in elemental form or in the form of its compounds. If the silver is utilized in elemental form, it preferably has a particle size range of from 0.1 to 100 μm. Smaller silver particle sizes can be attained by utilizing the elemental silver in colloidal form, whereby the silver has a particle size range of from 0.001 to 0.1 μm.

It is preferred, however, for the agent to contain a silver compound selected from the group consisting of silver acetate, silver citrate, silver diaminochloride complex, silver cyclodextrin complex, silver dicyanopotassium complex, silver phthalimide, silver phenylcyanamide, silver (ethylenethiourea) complex, silver imidazolate, transition metal-NHC-calix[4]arene complexes, silver crown ethers, and silver nitrate, and mixtures thereof. The silver compounds are preferably added in the form of solutions, suspensions, or dispersions. Particularly preferably, the liquid washing, cleaning, post-treatment, or auxiliary washing agent contains silver nitrate, which is utilized in the form of an aqueous solution.

The quantity of elemental silver and/or silver compound is preferably 0.0001 to 1 wt %, and more preferably between 0.001 and 0.25 wt %, based on the entire washing, cleaning, post-treatment, or auxiliary washing agent. Most preferred liquid washing, cleaning, post-treatment, or auxiliary washing agents in accordance with the present invention contain 0.01 to 0.1 wt % of elemental silver and/or a silver compound, based on the entire washing, cleaning, post-treatment, or auxiliary washing agent.

As a further essential constituent, the liquid washing, cleaning, post-treatment, or auxiliary washing agent contains non-neutralized fatty acid.

The quantity of non-neutralized fatty acid in the washing, cleaning, post-treatment, or auxiliary washing agent also depends on the quantity of silver or silver compound used. Generally, the quantity of non-neutralized fatty acid is preferably from 0.01% to 10%, more preferably 0.1% to 5%, and more strongly preferably 0.5 to 3%, in order to obtain optimum stabilization at minimal cost.

Furthermore it is preferred that the ratio of non-neutralized fatty acid to total silver (i.e. elemental silver and/or silver cation) be greater than or equal to 8 to 1. In order to achieve effective stabilization of the silver and/or silver compound, it is necessary to use the non-neutralized fatty acid in considerable excess. It has been found that with a ratio of non-neutralized fatty acid to elemental silver and/or to the quantity of silver cation of less than 8 to 1, sufficient stabilization is often not achieved and undesirable precipitation and/or color changes can take place.

Suitable fatty acids include octanoic acid, decanoic acid, lauric acid, myristic acid, palmitic acid, stearic acid, (hydrogenated) erucic acid, linoleic acid, linolenic acid, oleic acid, and behenic acid, as well as natural fatty acids such as for example coconut, palm-kernel, olive-oil, or tallow fatty acids.

The concentration of non-neutralized fatty acid present in a liquid washing or cleaning agent that contains fatty acid soap can be determined experimentally (e.g. by titration) or, when the pKa value of the fatty acid used is known, by calculation using the Henderson-Hasselbalch equation.

The washing, cleaning, post-treatment, or auxiliary washing agent contains 2 to 60 wt % of a surface-active agent selected from the group consisting of anionic, nonionic, cationic, and zwitterionic surfactants, and mixtures thereof.

The nonionic surfactants used are preferably alkoxylated (e.g. ethoxylated) primary alcohols having 8 to 18 carbon atoms and an average of 1 to 12 mole ethylene oxide (EO) per mole of alcohol, in which the alcohol residue can be linear or preferably methyl-branched in the 2- position, or can contain mixed linear and methyl-branched residues such as those that are usually present in oxo alcohol residues. Particularly preferred, however, are alcohol ethoxylates having linear residues made up of alcohols of natural origin having 12 to 18 carbon atoms, e.g. from coconut, palm, tallow, or oleyl alcohol, with an average of 2 to 8 moles ethoxylation per mole alcohol. The preferred ethoxylated alcohols include, for example, C₁₂₋₁₄ alcohols with 3 EO, 4 EO, or 7 EO, C₉₋₁₁ alcohol with 7 EO, C₁₃₋₁₅ alcohols with 3 EU, 5 EO, 7 EO, or 8 EO, C₁₂₋₁₈ alcohols with 3 EO, 5 EO, or 7 EO, and mixtures thereof, such as mixtures of C₁₂-C₁₄ alcohol with 3 EO and C₁₂-C₁₈ alcohol with 5 EU. The degrees of ethoxylation indicated represent statistical averages, which can correspond to an integer or a fractional number for a specific product. Preferred alcohol ethoxylates exhibit a restricted distribution of homologs (referred to as narrow range ethoxylates, or NRE). In addition to these nonionic surfactants, fatty alcohols with more than 12 EO can also be used. Examples of these are tallow fatty alcohol with 14 EO, 25 EO, 30 EU, or 40 EO. Nonionic surfactants that contain EO and PO groups together in the molecule are also usable according to the present invention.

In terms of performance and biodegradability, it is particularly preferred to use a linear ethoxylated alcohol having 8 to 18 carbon atoms with an average of 1 to 12 moles ethylene oxide per mole alcohol.

A further class of preferred nonionic surfactants include the amine oxides, for example N-cocoyl-N,N-dimethylamine oxide and N-tallowyl-N,N-dihydroxyethylamine oxide. These are particularly desirable for use in textile washing agents since they possess good cleaning performance on specific stains such as motor oil.

The concentration of nonionic surfactant for use in the washing, cleaning, post- treatment, or auxiliary washing agent of the present invention is preferably 2 to 40 wt %, by preference 4 to 30 wt %, and in particular, 5 to 15 wt %, based in each case on the entire washing, cleaning, post-treatment, or auxiliary washing agent.

In addition to the nonionic surfactant(s), the surfactant mixture of the washing, cleaning, post-treatment, or auxiliary washing agent may also include an anionic surfactant. Sulfonates, sulfates, soaps, and mixtures thereof are preferably used as an anionic surfactant.

Sulfonate surfactants preferably include the C₉₋₁₃ alkylbenzenesulfonates, olefinsulfonates, (i.e. mixtures of alkene- and hydroxyalkanesulfonates), and the disulfonates, for example such as those obtained from C₁₂₋₁₈ monoolefins having a terminal or internal double bond, by sulfonation with gaseous sulfur trioxide and subsequent alkaline, or acid hydrolysis of the sulfonation products. Also suitable are alkanesulfonates obtained from C₁₂₋₁₈ alkanes, for example by sulfochlorination or sulfoxidation with subsequent hydrolysis and neutralization. The esters of α-sulfo fatty acids (estersulfonates), e.g. the α-sulfonated methyl esters of hydrogenated coconut, palm-kernel, or tallow fatty acids, are likewise suitable.

Preferred alk(en)yl sulfates are the alkali, and in particular sodium, salts of the sulfuric acid semi-esters of the C₁₂ to C₁₈ fatty alcohols, for example from coconut fatty alcohol, tallow fatty alcohol, lauryl, myristyl, cetyl, or stearyl alcohol, or the C₁₀ to C₂₀ oxo alcohols, and those semi-esters of secondary alcohols of those chain lengths. For purposes of washing performance, the C₁₂ to C₁₆ alkyl sulfates and C₁₂ to C₁₅ alkyl sulfates, as well as C₁₄ to C₁₅ alkyl sulfates, are preferred anionic surfactants.

The sulfuric acid monoesters of straight-chain or branched C₇₋₂₁ alcohols ethoxylated with 1 to 6 moles ethylene oxide, such as 2-methyl-branched C₉₋₁₁ alcohols having an average of 3.5 moles ethylene oxide (EO) or C₁₂₋₁₈ fatty alcohols having 1 to 4 moles EO, are also suitable.

Soaps are also preferred anionic surfactants. Saturated and unsaturated fatty acid soaps, such as the salts of lauric acid, myristic acid, palmitic acid, stearic acid, (hydrogenated) erucic acid and behenic acid, are suitable, as well as soap mixtures derived from natural fatty acids, e.g. coconut, palm-kernel, olive-oil, or tallow fatty acids.

The anionic surfactants, including the soaps, may be present as their sodium, potassium, or magnesium salts. The anionic surfactants are preferably present as sodium salts. Further preferred counter ions for the anionic surfactants are also the protonated forms of choline, triethylamine, or methylethylamine.

It may be preferred for the washing, cleaning, post-treatment, or auxiliary washing agent to contain both the neutralized and the non-neutralized form of a fatty acid. This is particularly advantageous with liquid washing, cleaning, post-treatment, or auxiliary washing agents containing fatty acid soaps, since in these compositions the quantity of non-neutralized fatty acid necessary for stabilization of the silver or the silver cation can be adjusted simply pH, for example by the addition of pH adjusting agents.

Alternatively, the fatty acid soap may be derived from a fatty acid other than the fatty acid used to stabilize the elemental silver and/or the silver cation.

It has been found that particularly stable and aesthetically attractive washing or cleaning agents containing both silver and/or a silver compound as well as fatty acid soap are obtained when the ratio of non-neutralized fatty acid to fatty acid soap is between 5:95 and 60:40, and more preferably between 10:90 and 40:60.

Post-treatment agents in the form of fabric softeners may contain cationic surfactants that possess fabric-softening effect.

The cationic surfactants encompass, for example, quaternary ammonium compounds such as monoalk(en)yltrimethylammonium compounds, dialk(en)yldimethylammonium compounds, and the mono-, di- or triesters of fatty acids with alkanolamines.

Suitable examples of quaternary ammonium compounds are, for example, shown in formulas (I) to (III)

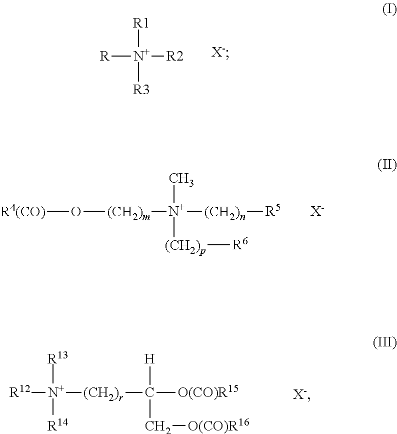

wherein formula (I): R denotes an acyclic alkyl residue having 12 to 24 carbon atoms; R¹ denotes a saturated C₁ to C₄ alkyl or hydroxyalkyl residue; R² and R³ either are identical to R or R′, or denotes an aromatic residue; and X- denotes either a halide, methosulfate, methophosphate, or phosphate ion, or mixtures thereof. Examples of cationic compounds of formula (I) include tallow trimethyl ammonium chloride, stearyl trimethyl ammonium chloride, didecyl dimethyl ammonium chloride, ditallow dimethyl ammonium chloride, and dihexadecyl dimethyl ammonium chloride.

Compounds represented by formulas (II) and (III) are the so-called esterquats. Esterquats are notable for outstanding biodegradability. In formula (II), R⁴ denotes an aliphatic alk(en)yl residue having 12 to 22 carbon atoms with 0, 1, 2, or 3 double bonds and/or optionally with substituents; R⁵ denotes H, OH, or O(CO)R⁷; and R⁶ denotes, independently of R⁵, H, OH, or O(CO)R⁸, R⁷ and R⁸ each denoting, mutually independently, an aliphatic alk(en)yl residue having 12 to 22 carbon atoms with 0, 1, 2, or 3 double bonds; m, n, and p can each, mutually independently, have the value 1, 2, or 3; and X- can be either a halide, methosulfate, methophosphate, or phosphate ion, as well as mixtures of these ions. Compounds in which R⁵ represents the group O(CO)R⁷ are preferred. Compounds in which R⁵ represents the group O(CO)R⁷, and R⁴ and R⁷ are alkyl residues having 16 to 18 carbon atoms, are particularly preferred. Compounds in which R⁶ additionally denotes OH are especially preferred. In formula (III), R¹², R¹³, and R¹⁴ mutually independently denote a C₁₋₄ alkyl, alkenyl, or hydroxyalkyl group, R¹⁵ and R¹⁶, each selected independently, denote a C₈₋₂₈ alkyl group, X- is an anion, and r is a number between 0 and 5. Examples include methyl-N-(2-hydroxyethyl)-N,N-di(tallowacyloxyethyl) ammonium methosulfate, bis(palmitoyloxyethy)lhydroxyethylmethyl ammonium methosulfate, 1,2-bis-[tallowacyloxy]-3-trimethylammoniumpropane chloride, methyl-N,N-bis(stearoyloxyethyl)-N-(2-hydroxyethyl)ammonium methosulfate, and N,N-dimethyl-N,N-di(tallowacyloxyethyl) ammonium methosulfate.

Instead of the ester group O(CO)R in which R denotes a long-chain alk(en)yl residue, it is possible to use fabric-softening compounds that comprise the following groups: RO(CO), N(CO)R, or RN(CO). Out of these groups, the N(CO)R groups are preferred.

A further advantageous ingredient of the washing, cleaning, post-treatment, or auxiliary washing agents can be ammonium hydroxide. It has been found that even small quantities (e.g. 0.01 wt %) of ammonium hydroxide, based on the entire washing, cleaning, post-treatment, or auxiliary washing agent, result in very clear and thus aesthetically very attractive agents.

In addition to the surfactants, the silver or silver compound, and the non- neutralized fatty acid, the washing, cleaning, post-treatment, or auxiliary washing agent of the present invention may contain additional ingredients that further improve the applications-engineering and/or aesthetic properties of the washing, cleaning, post-treatment, or auxiliary washing agent. In the context of the present invention, the washing, cleaning, post-treatment, or auxiliary washing agent additionally may contain one or more substances from the group consisting of detergency builders, bleaching agents, bleach catalysts, bleach activators, enzymes, electrolytes, nonaqueous solvents, pH adjusting agents, perfume oil, perfume carriers, fluorescing agents, dyes, hydrotopes, foam inhibitors, silicone oils, anti-redeposition agents, anti-gray agents, shrinkage preventers, wrinkle protection agents, color transfer inhibitors, antimicrobial active substances, germicides, fungicides, antioxidants, preservatives, corrosion inhibitors, antistatic agents, bittering agents, ironing adjuvants, proofing and impregnating agents, swelling and anti-slip agents, fabric-softening components, and UV absorbers.

For aesthetic reasons, soluble organic detergency builders are preferred as detergency builders for use in the washing, cleaning, post-treatment, or auxiliary washing agents.

Organic detergency builders include, for example, the polycarboxylic acids usable in the form of their sodium salts, “polycarboxylic acids” being understood as those carboxylic acids that carry more than one acid function. These include, for example, citric acid, adipic acid, succinic acid, glutaric acid, malic acid, tartaric acid, maleic acid, fumaric acid, sugar acids, aminocarboxylic acids, nitrilotriacetic acid (NTA), methylglycinediacetic acid (MGDA) and their derivatives, as well as mixtures thereof. Preferred salts are the salts of the polycarboxylic acids such as citric acid, adipic acid, succinic acid, glutaric acid, tartaric acid, sugar acids, and mixtures thereof. The free acids themselves can also be used. The acids typically possess not only a detergency builder effect, but also the property of an acidifying component. Polymeric polycarboxylates are also suitable as detergency builders.

Citric acid, or salts thereof, is preferably used as soluble organic detergency builders in the liquid washing, cleaning, post-treatment, or auxiliary washing agents of the present invention.

The liquid washing, cleaning, post-treatment, or auxiliary washing agent can also comprise an enzyme or a mixture of enzymes. Particularly suitable include those enzymes selected from the subclasses of the hydrolases, such as proteases, (poly)esterases, lipases or lipolytically active enzymes, amylases, cellulases and other glycosyl hydrolases, hemicellulase, cutinases, β-glucanases, oxidases, peroxidases, mannanases, tannases, esterases/polyesterases, perhydrolases, oxyreductases, and/or laccases.

To stabilize the enzymes, the washing, cleaning, post-treatment, or auxiliary washing agents according to the present invention can contain stabilizing agents such as boric acid or borates, boric acid derivatives, or aminoalcohols.

The use of pH adjusting agents may be required to bring the pH of the washing, cleaning, post-treatment, or auxiliary washing agent into the desired range. All known acids and alkalis are usable for pH adjustment. Preferred pH adjusting agents are NaOH and citric acid.

The pH of the washing, cleaning, post-treatment, or auxiliary washing agent is preferably between 5 and 8.5, and more preferably between 7.5 and 8.5.

The washing, cleaning, post-treatment, or auxiliary washing agent preferably comprises a perfume. Individual fragrance compounds, for example the synthetic products of the ester, ether, aldehyde, ketone, alcohol, and hydrocarbon types, can be used as perfume oils. It is preferred, however, to use mixtures of different fragrances that together produce an attractive scent note. Such perfume oils can also contain natural fragrance mixtures such as those accessible from plant sources.

The washing, cleaning, post-treatment, or auxiliary washing agents according to the present invention can be used to wash and/or clean and/or condition textile fabrics.

One method of manufacturing the washing, cleaning, post-treatment, or auxiliary washing agents according to the present invention is to add silver to the finished liquid agent. Post-added silver may be in a solid form, preferably finely dispersed, and/or as a solution, suspension, or dispersion of silver in suitable solvents. Silver compounds, as well as solutions, suspensions, or dispersions of silver compounds, are also usable according to the present invention.

A liquid washing or cleaning agent is manufactured by means of usual and known method and processes. For example, the constituents of the washing or cleaning agents can simply be mixed in agitator vessels, whereby the vessel is usually charged with water first, and then the acid components, (if they are required), such as the alkylarylsulfonates, citric acid, boric acid, phosphonic acid, the fatty alcohol ether sulfates, etc., and the nonionic surfactants. The nonaqueous solvents, if present, are preferably also added at this time, but that addition can also occur at a later time. The non-neutralized fatty acid is then added, and the further constituents are added thereafter, preferably in portions.

If the liquid washing, cleaning, post-treatment, or auxiliary washing agent also contains neutralized fatty acid, it is useful, after addition of the surfactants and the nonaqueous solvent (if present), to prepare a base (including ammonium hydroxide, if present), then to add the non-neutralized fatty acid, and then to saponify a portion of the non-neutralized fatty acid at 50 to 60° C. The further constituents are added thereafter, preferably in portions.

Production of a fabric softener post-treatment agent may be obtained in accordance with techniques familiar to one skilled in the art of manufacturing fabric softeners. This can be done, for example, by mixing the raw materials, optionally with the use of high-shear mixing equipment. It is recommended to melt the cationic surfactant and then disperse the melt in a solvent, preferably water. Additional ingredients, including the non-neutralized fatty acid, can be integrated into the fabric softener by simply mixing them in.

In all cases, the silver or silver compound is added as a last step.

It may also be preferable to generate the silver colloidally in the washing, cleaning, post-treatment, or auxiliary washing agent by homogenization in a colloid mill or by arc atomization of a silver wire.

TABLE 1 shows the composition of a comparison formula V1 and the compositions of five washing or cleaning agents E1 to E5 according to the present invention (all quantities are indicated as wt % active substance, based on the total agent composition):

TABLE 1
Exemplary Washing or Cleaning Agents

| Ingredient (wt % actives) | V1 | E1 | E2 | E3 | E4 | E5 |
|---|---|---|---|---|---|---|
| C₁₂₋₁₈ fatty alcohol with 7 EO | 12 | 12 | 12 | 12 | 12 | 12 |
| N-cocoyl-N,N-dimethylamine oxide | 2 | 2 | 2 | 2 | 2 | 2 |
| AgNO₃ | 0.017 | 0.017 | 0.017 | 0.017 | 0.017 | 0.017 |
| Farnesol | 0.02 | 0.02 | 0.02 | 0.02 | 0.02 | 0.02 |
| C₁₄ fatty acid | 1.61 | 1.61 | 1.61 | 1.61 | 1.61 | 1.61 |
| Citric acid | 0.1 | 0.1 | 0.1 | 0.1 | 0.1 | 0.22 |
| NaOH | 0.38 | 0.32 | 0.23 | 0.18 | 0.13 | 0.13 |
| NH₄OH | 0.06 | 0.06 | 0.06 | 0.06 | 0.06 | 0.06 |
| Water | to 100 | to 100 | to 100 | to 100 | to 100 | to 100 |
| pH | 11.5 | 10.04 | 8.99 | 8.5 | 8.03 | 7.5 |
| Non-neutralized fatty acid (wt % in agent) | 0.0007 | 0.0206 | 0.2033 | 0.4970 | 0.9150 | 1.316 |
| Fatty acid soap (wt % in agent) | 1.6093 | 1.5894 | 1.4067 | 1.1130 | 0.6950 | 0.2940 |
| % non-neutralized fatty acid | 0 | 1.3 | 12.6 | 30.9 | 56.8 | 81.7 |
| % fatty acid soap | 100 | 98.7 | 87.4 | 69.1 | 43.2 | 18.3 |
| Non-neutralized fatty acid:silver cation | — | 2:1 | 20:1 | 50:1 | 92:1 | 132:1 |

The concentration of non-neutralized fatty acid and fatty acid soap was determined using the Henderson-Hasselbalch equation, utilizing a pKa value of 8.15 for myristic acid (J. R. Kanicky, A. F. Poniatowski, N. R. Mehta, and D. Shah, Langmuir, Vol. 16, pp. 172-177, 2000).

The washing, cleaning, post-treatment, or auxiliary washing agent V1 exhibited a definite color change several hours after manufacture. The washing, cleaning, post-treatment, or auxiliary washing agents E2 to E4, on the other hand, were still clear even after four weeks, exhibiting absolutely no color change. The washing, cleaning, post-treatment, or auxiliary washing agent E6 also exhibited no color change even after four weeks, but was slightly cloudy from the beginning. The washing, cleaning, post-treatment, or auxiliary washing agent E1 also exhibited a color change, but this occurred much later and more weakly than in the case of the washing or cleaning agent V1.

TABLE 2 shows the compositions of six additional washing, cleaning, post-treatment, or auxiliary washing agents according to the present invention, indicated as E6 to E11 (wherein all ingredient quantities are indicated as wt % active substance, based on the total weight of the agent):

TABLE 2
Additional Washing, Cleaning, Post-Treatment or Auxiliary Washing Agents.

| Ingredient (wt % actives) | E6 | E7 | E8 | E9 | E10 | E11 |
|---|---|---|---|---|---|---|
| C₁₂₋₁₈ oxoalcohol with 7 EO | 12 | 12 | 12 | — | 5 | — |
| Linear C₁₁₋₁₃ alkylbenzoic acid | — | — | — | — | 12 | — |
| AgNO₃ | 0.017 | 0.017 | 0.017 | 0.04 | 0.017 | 0.017 |
| Farnesol | 0.05 | 0.05 | 0.02 | — | 0.05 | 0.05 |
| Coconut fatty acid | 5.13 | 5 | 5.07 | 1.25 | 2.0 | 10.0 |
| Citric acid | 1 | 0.15 | 0.1 | — | 1 | — |
| NaOH | — | 1.99 | 1.49 | 0.48 | 0.48 | 3.43 |
| NH₄OH | 3.05 | 0.01 | — | — | 0.4 | — |
| Water | to 100 | to 100 | to 100 | to 100 | to 100 | to 100 |
| pH | 8.6 | 11.4 | 8.15 | 11.5 | 8.7 | 8.6 |

The washing, cleaning, post-treatment, or auxiliary washing agents E6 to E11 remained clear formulations even after four weeks, exhibiting no, or only very slight, color changes.

The washing, cleaning, post-treatment, or auxiliary washing agents E1 to E11 showed good effectiveness against both Gram positive test germs (Staphylococcus aureus, Staphylococcus epidermidis) and against yeasts (Candida albicans).

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

We claim:

1. A liquid washing, cleaning, post-treatment, or auxiliary washing agent comprising:
a) from 2 to 60% by weight, based on the total weight of the agent, of a surfactant selected from the group consisting of anionic, nonionic, cationic, and zwitterionic surfactants, and mixtures thereof;
b) at least one of elemental silver and a silver compound; and
c) a non-neutralized fatty acid.

2. The agent of claim 1, wherein the silver compound is selected from the group consisting of silver acetate, silver citrate, silver diaminochloride complex, silver cyclodextrin complex, silver dicyanopotassium complex, silver phthalimide, silver phenylcyanamide, silver (ethylenethiourea) complex, silver imidazolate, transition metal-NHC-calix[4]arene complexes, silver crown ethers, and silver nitrate, and mixtures thereof.

3. The agent of claim 1, wherein the at least one of elemental silver and a silver compound is present from 0.0001 to 1% by weight, based on the total weight of the agent.

4. The agent of claim 1, wherein the ratio of non-neutralized fatty acid to silver is greater than or equal to 8 to 1.

5. The agent of claim 1, wherein the non-neutralized fatty acid is present from 0.01 to 10% by weight, based on the total weight of the agent.

6. The agent of claim 1 further comprising from 0.01 to 3% by weight ammonium hydroxide, based on the total weight of the agent.

7. The agent of claim 1, further comprising a neutralized fatty acid.

8. The agent of claim 1 comprising at least one cationic surfactant present from 0.5 to 50% by weight, based on the total weight of the agent.

9. The agent of claim 1, further comprising one or more substances selected from the group consisting of detergency builders, bleaching agents, bleach catalysts, bleach activators, enzymes, electrolytes, nonaqueous solvents, pH adjusting agents, perfume oil, perfume carriers, fluorescing agents, dyes, hydrotopes, foam inhibitors, silicone oils, anti-redeposition agents, anti-gray agents, shrinkage preventers, wrinkle protection agents, color transfer inhibitors, antimicrobial active substances, germicides, fungicides, antioxidants, preservatives, corrosion inhibitors, antistatic agents, bittering agents, ironing adjuvants, proofing and impregnating agents, swelling and anti-slip agents, fabric-softening components, and UV absorbers, and mixtures thereof.

10. A method of stabilizing a liquid washing, cleaning, post-treatment, or auxiliary washing agent comprising:
a) 2 to 60% by weight, based on the total weight of the agent, of a surfactant selected from the group consisting of anionic, nonionic, cationic, and zwitterionic surface-active agents and mixtures thereof,
b) at least one of elemental silver and a silver compound, said method comprising the steps of:
(1) forming said agent by combining (a) and (b); and
(2) adding from 0.01 to 10% by weight non-neutralized fatty acid to said agent, said weight percentage of non-neutralized fatty acid based on the total weight of the agent, wherein the ratio of non-neutralized fatty acid to silver is 8:1 or greater.

11. A method of manufacturing a liquid washing, cleaning, post-treatment, or auxiliary washing agent of claim 1, said method comprising the steps of: (1) first combining said components (a) and (c) and then post-adding at least one of elemental silver and a silver compound to the resulting mixture comprising (a) and (c).
